(19) United States
(12) Patent Application Publication
(10) Pub. No.: US 2008/0070114 A1
(43) Pub. Date: Mar. 20, 2008

(54) Alkaline Battery

(75) Inventors: Fumio Kato, Osaka (JP); Katsuya Sawada, Osaka (JP); Yasuo Mukai, Osaka (JP); Shigeto Noya, Osaka (JP)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial CO.,LTD., Osaka (JP)

(21) Appl. No.: 11/630,335

(22) PCT Filed: Jun. 16, 2005
(86) PCT No.: PCT/JP05/11019

§ 371 Date: Dec. 21, 2006

(30) Foreign Application Priority Data
Jun. 28, 2004 (JP) 2004-189701

(51) Int. Cl. H01M 6/02

(52) U.S. Cl. 429/206

(57) ABSTRACT

An alkaline battery including a positive electrode, a negative electrode and an alkaline electrolyte, wherein the positive electrode includes a positive electrode material mixture including nickel oxyhydroxide, electrolytic manganese dioxide and expanded graphite, the expanded graphite has an average particle diameter on a volume basis of 5 to 25 μm, a BET specific surface area of 4 to 10 m²/g, and a bulk specific gravity (apparent density) measured by a static method of 0.03 to 0.10 g/cm³, the nickel oxyhydroxide has an average nickel valence of not less than 3.05, and a content of the expanded graphite in a total amount of the nickel oxyhydroxide, the electrolytic manganese dioxide and the expanded graphite that are included in the positive electrode material mixture of 3 to 15 wt %.

### TECHNICAL FIELD

The present invention relates to alkaline batteries including manganese dioxide and nickel oxyhydroxide as active materials in the positive electrode material mixture, and more particularly relates to a nickel-manganese battery as a primary battery.

### BACKGROUND ART

Alkaline batteries as primary batteries, typified by an alkaline-manganese dry battery, have an inside-out type structure that includes a positive electrode case also serving as a positive electrode terminal, a cylindrical positive electrode material mixture pellet comprising manganese dioxide and being disposed inside the positive electrode case in close contact therewith, and a gel-like zinc negative electrode disposed in the hollow of the positive electrode material mixture pellet with a separator interposed therebetween. In general, the positive electrode material mixture of the alkaline battery includes electrolytic manganese dioxide and a graphite conductive material.

With the recent wide spread use of digital devices, the load power for the devices for which alkaline batteries are used has gradually increased, so that there is an increasing demand for batteries exhibiting excellent heavy load discharge performance. In order to meet this demand, it has been proposed to mix nickel oxyhydroxide into a positive electrode material mixture to improve the heavy load discharge characteristics of batteries (see Patent Document 1). It has been also proposed for a positive electrode material mixture to contain an oxide such as a zinc oxide, a calcium oxide, an yttrium oxide or titanium dioxide from the viewpoint of providing an alkaline battery that maintains its heavy load discharge performance even after long term storage at a high temperature (Patent Document 2). In recent years, alkaline batteries as described above have been put into practical use, and are being widely used.

In general, nickel oxyhydroxide used for alkaline batteries is obtained by oxidizing spherical or oval nickel hydroxide for use in alkaline storage batteries (alkaline secondary batteries) such as a nickel-cadmium storage battery and a nickel-metal hydride storage battery (see Patent Document 3) with an oxidizing agent such as a sodium hypochlorite aqueous solution.

In order to achieve high-density packing into the batteries, nickel hydroxide comprising a βtype structured crystal and having a large bulk specific gravity (apparent density) or tap density is used as the source material at this time. By treating such a source material with an oxidizing agent, nickel oxyhydroxide comprising a β-type structured crystal can be obtained. In nickel oxyhydroxide comprising a β-type structured crystal that has been produced by chemical treatment, the nickel valence is approximately 3. The electrochemical energy generated when the nickel is reduced from a valence of approximately 3 to a valence near 2 is utilized as the discharge capacity of a battery.

For the purpose of improving the heavy load discharge characteristics of a battery, nickel hydroxide (see Patent Document 4) including cobalt, zinc or the like for use in alkaline storage batteries is occasionally used as the source material. In the crystal of such nickel hydroxide, cobalt, zinc or the like is dissolved to form a solid solution nickel hydroxide.

In the field of the alkaline storage batteries, it has been proposed to achieve a significant increase in the capacity by intentionally forming nickel oxyhydroxide comprising a γ-type structured crystal and having an average valence of nickel near 3.5 during charging (see Patent Documents 5 to 7). In such a proposal, a solid solution nickel hydroxide comprising a β-type structured crystal and including a transition metal such as manganese dissolved therein is used as the source material of the active material. However, such an alkaline storage battery has a problem in its cycle life and the like, and has not yet been put into practical use.

On the other hand, in the field of primary batteries including alkaline-manganese dry batteries, it has been proposed to add a small amount of expanded graphite into a positive electrode material mixture, thereby improving the moldability of a positive electrode material mixture pellet, while improving the conductivity at the same time (see Patent Document 8). For nickel-manganese batteries using manganese dioxide and nickel oxyhydroxide in the positive electrode material mixture, it has been proposed to add a graphite powder having a BET specific surface area of 3 to 4 m²/g and an average particle diameter of 8 to 35 μm to the positive electrode material mixture from the viewpoint of improving the storage characteristics (see Patent Document 9). Furthermore, for nickel dry batteries using only nickel oxyhydroxide in the positive electrode material mixture, it has been proposed to add expanded graphite having an average particle diameter of 5 to 20 μm as a conductive material to the positive electrode material mixture for the purpose of improving the conductivity of the positive electrode material mixture and the moldability of the pellet (see Patent Document 10).

Patent Document 1 Japanese Laid-Open Patent Publication No. Sho 57-72266

Patent Document 2 Japanese Laid-Open Patent Publication No. 2001-15106

Patent Document 3 Japanese Examined Patent Publication No. Hei 4-80513

Patent Document 4 Japanese Examined Patent Publication No. Hei 7-77129

Patent Document 5 Domestic re-publication of WO97/19479

Patent Document 6 Japanese Laid-Open Patent Publication No. Hei 10-149821

Patent Document 7 Japanese Patent No. 3239076 specification

Patent Document 8 Japanese Laid-Open Patent Publication No. Hei 9-35719

Patent Document 9 Japanese Laid-Open Patent Publication No. 2001-332250

Patent Document 10 Japanese Laid-Open Patent Publication No. 2003-17080

### DISCLOSURE OF THE INVENTION

### Problem That the Invention is To Solve

As a result of various studies for using a solid solution nickel hydroxide or nickel oxyhydroxide, each of which has been studied in the field of the alkaline storage batteries, for primary battery applications, the inventors have found that the battery capacity can be significantly increased by using highly oxidized nickel oxyhydroxide as the source material. Highly oxidized nickel oxyhydroxide can be produced, for example, using nickel hydroxide comprising a β-type structured crystal and including manganese dissolved therein, as the source material.

However, highly oxidized nickel oxyhydroxide includes a γ-type structured crystal. Since nickel oxyhydroxide comprising a γ-type structured crystal (γ—NiOOH) experiences structural change during discharging to become a β-type or α-type nickel hydroxide, it undergoes a large volume change. Consequently, it is not possible to successfully ensure current collection between the active material particles during discharging, so that the heavy load discharge characteristics are more likely to be reduced than in an alkaline battery produced using nickel oxyhydroxide comprising a β-type structured crystal that is close to a single phase (β-nickel oxyhydroxide) (nickel valence: 3.0). Accordingly, in the case of obtaining an alkaline battery exhibiting excellent heavy load discharge characteristics by mixing nickel oxyhydroxide with manganese dioxide, whose utilization is low during heavy load discharging, there may be cases where the effect of improving the heavy load discharge characteristics cannot be obtained sufficiently.

### Means for Solving the Problem

The present invention relates to an alkaline battery including a positive electrode, a negative electrode and an alkaline electrolyte, and the positive electrode includes a positive electrode material mixture including nickel oxyhydroxide, electrolytic manganese dioxide and expanded graphite. Here, the expanded graphite has: (1) an average particle diameter on a volume basis of 5 to 25 μm; (2) a BET specific surface area of 4 to 10 m²/g; and (3) a bulk specific gravity (apparent density) measured by a static method of 0.03 to 0.10 g/cm³. Further, the nickel oxyhydroxide has an average nickel valence of not less than 3.05. The content of the expanded graphite in the total amount of the nickel oxyhydroxide, the electrolytic manganese dioxide and the expanded graphite that are included in the positive electrode material mixture is 3 to 15 wt %.

### EFFECT OF THE INVENTION

Expanded graphite is constituted by particles obtained by expanding graphite having a developed crystal structure or extending its interlayer spacing by heat treatment with sulfuric acid, nitric acid or the like. Expanded graphite has electron conductivity as high as that of common graphites such as natural graphite, and is excellent in compressibility for exerting buffering action and in capability of relaxing the stress inside the positive electrode material mixture.

That is, even if highly oxidized nickel oxyhydroxide including a γ-type structured crystal undergoes volume change peculiar thereto during discharging of the battery, the particles of expanded graphite act as a buffering material for the volume change; therefore, it is possible to ensure sufficient electrical connection between the active material particles (nickel oxyhydroxide and electrolytic manganese dioxide). Accordingly, it is possible to provide an alkaline battery having high capacity under a wide range of discharge conditions, varying from low load discharging to heavy load discharging.

Furthermore, since the BET specific surface area of expanded graphite is suppressed relatively low, the reaction between the graphite and the electrolyte is reduced, making it possible to maintain the storage characteristics of the nickel-manganese battery in a excellent state.

### BRIEF DESCRIPTION OF THE DRAWINGS

FIG. 1 is a front view, partially in cross section, showing a nickel-manganese battery according to an example of the present invention.

### BEST MODE FOR CARRYING OUT THE INVENTION

The present invention relates to an alkaline battery including a positive electrode, a negative electrode and an alkaline electrolyte, and the positive electrode includes a positive electrode material mixture including nickel oxyhydroxide, electrolytic manganese dioxide and expanded graphite. The nickel oxyhydroxide and the electrolytic manganese dioxide serve as positive electrode active materials, and the expanded graphite basically serves as a conductive material.

Here, the nickel oxyhydroxide has an average nickel valence of not less than 3.05, and preferably not less than 3.1. The reason is that the present invention is to achieve a significant capacity increase of the battery by using highly oxidized nickel oxyhydroxide.

Highly oxidized nickel oxyhydroxide can be easily obtained, for example, by chemically oxidizing a solid solution nickel hydroxide including manganese dissolved therein. When manganese is dissolved in nickel hydroxide, which is the source material of nickel oxyhydroxide, the redox potential of the nickel hydroxide shifts to a lower value. Therefore, highly oxidized nickel oxyhydroxide can be easily obtained. From the viewpoint of making the density of the nickel oxyhydroxide as high as possible, it is preferable that the solid solution nickel hydroxide including manganese dissolved therein comprises a β-type structured crystal.

In the nickel hydroxide as the source material of the nickel oxyhydroxide, the content of manganese in the total of the nickel and the manganese is preferably 1 to 7 mol %, and more preferably 2 to 5 mol %. When the content of manganese is less than 1 mol %, it is difficult to obtain highly oxidized nickel oxyhydroxide as described above easily. On the contrary, when the content of manganese exceeds 7 mol %, the proportion of nickel in the nickel hydroxide becomes relatively low, so that it is difficult to achieve a sufficient battery capacity. When nickel hydroxide as described above is used as the source material, the content of manganese in the total of the nickel and the manganese that are included in the nickel oxyhydroxide is also 1 to 7 mol %.

It is preferable that a cobalt oxide is attached to the surface of the particles of the nickel oxyhydroxide. Nickel oxyhydroxide having a cobalt oxide on the surface of its particles has an improved capability of current collection through the particles, and therefore the discharge characteristics are further improved especially in a heavy load region.

Furthermore, the amount of the cobalt oxide is preferably not more than 7 wt %, and more preferably 2 to 5 wt %, relative to the amount of the nickel oxyhydroxide. When the amount of the cobalt oxide exceeds 7 wt % of the nickel oxyhydroxide and thus becomes excessive, there is the possibility that the cobalt may be, for example, eluted into the electrolyte, leading to a decrease in the reliability of the battery during high temperature storage. However, in order to further improve the discharge characteristics in a heavy load region, the amount of the cobalt oxide used is preferably at least not less than 2 wt %, relative to the amount of the nickel oxyhydroxide.

Highly oxidized nickel oxyhydroxide includes a γ-type structured crystal, and therefore undergoes a large volume change with discharging of the battery. From the viewpoint of suppressing this, the present invention requires use of expanded graphite.

Here, the expanded graphite has the following physical properties.

It is preferable that the expanded graphite has a small average particle diameter on a volume basis (D₅₀), which is required to be set to not more than 25 μm, and preferably not more than 20 μm, in view of the dispersibility in the positive electrode material mixture. However, the smaller the average particle diameter of the expanded graphite, the harder the pressure molding of the positive electrode material mixture becomes, so that the average particle diameter is required to be set to not less than 5 μm, and preferably not less than 10 μm.

When the BET specific surface area of the expanded graphite is too small, the electrolyte retention of the positive electrode material mixture decreases to reduce the discharge characteristics of the battery, so that it is required to be set to not less than 4 m²/g, and preferably not less than 5 m²/g. On the other hand, when the BET specific surface area of the expanded graphite is too large, the oxidation degradation of the graphite tends to accelerate to reduce the storage characteristics of the battery, and therefore the BET specific surface area is required to be set to not more than 10 m²/g, and preferably not more than 8 m²/g.

Furthermore, it seems that, when the bulk specific gravity (apparent density) of the expanded graphite measured by a static method is lower, a larger number of vertical edges are exposed on the basal surface of the expanded graphite particles, and the edges extend in a state suitable for current collection; therefore, the bulk specific gravity is required to be set to not more than 0.10 g/cm³, and preferably not more than 0.08 g/cm³. On the other hand, since the pressure molding of the positive electrode material mixture becomes difficult when the bulk specific gravity is too low, the bulk specific gravity is required to be set to at least not less than 0.03 g/cm³, and preferably not less than 0.05 g/cm³.

Expanded graphite is a graphite material obtained by subjecting graphite to expansion treatment. In the expansion treatment, microscopically, different ion, such as sulfate ion, or the like enters into the crystal plane of the graphite structure, thus expanding the (002) plane. On the other hand, macroscopically, the crystallite of the graphite becomes miniaturized to reduce the crystallinity. The greater the extent of these structural changes, the easier the properties such as compressibility or stress relaxation are to achieve. That is, in the present invention, it is preferable to use expanded graphite that has been subjected to a sufficient expansion treatment.

In view of the foregoing, it is preferable that the expanded graphite satisfies the following physical properties.

First, the interplanar spacing of the (002) plane: d₀₀₂ determined by powder X-ray diffraction is preferably expanded sufficiently, and preferably not less than 3.37 Å (angstrom).

Furthermore, the crystallite size Lc (002): of the expanded graphite is preferably sufficiently small, and preferably not more than 300 Å (angstrom). Here, “Lc (002)” means a crystallite size calculated from the half-width of an X-ray diffraction peak attributed to the (002) plane, using the Scherrer's equation.

A battery including nickel oxyhydroxide in the positive electrode material mixture has a high positive electrode potential, and therefore tends to experience oxidation degradation of the graphite conductive material when stored at a high temperature. This phenomenon is particularly prominent in those graphites that have a high impurity (e.g., volatile component) content. Furthermore, when the iron content is included in the positive electrode material mixture, the iron is converted into complex ion during storage of the battery and complex ion is eluted into the electrolyte to be precipitated on the negative electrode, thus causing a capacity decrease. From the viewpoint of reducing such a problem and ensuring the reliability of the battery, in the present invention, it is preferable to use high-purity graphite as the precursor of the expanded graphite, and subject this to expansion treatment.

Specifically, the impurity content of the graphite serving as the precursor is preferably not more than 0.2 wt %. Furthermore, the iron content constituting the impurity is preferably not more than 0.05 wt % of the graphite serving as the precursor.

It should be noted that the impurity content of the graphite can be determined in accordance with Japanese Industrial Standards (JIS) M8812. More specifically, when the water content is determined by measuring the dry weight, the volatile content is determined by measuring the heated weight, and the ash content is determined by measuring the mass of the residue after incineration (ash component), the sum total of these represents the impurity content. Furthermore, the iron content can be determined by dissolving the above-described ash component with acid and carrying out ICP emission spectrometry. Examples of the ICP emission spectrometry apparatus include “VISTA-RL” manufactured by VARIAN, Inc.

As the expansion treatment, it is preferable to use a method in which high purity graphite is heated together with acid. As the acid used at that time, sulfuric acid, nitric acid or the like is preferable.

From the viewpoint of securing the volume energy density of the active material in the positive electrode material mixture, the content of the expanded graphite in the total amount of the nickel oxyhydroxide, the electrolytic manganese dioxide and the expanded graphite that are included in the positive electrode material mixture is preferably small. On the other hand, when the content of the expanded graphite in the above-described total amount is too small, it is impossible to ensure sufficient heavy load discharge characteristics, while obtaining sufficient buffering action for the volume change of the nickel oxyhydroxide. In view of the balance in required characteristics as described above, the content of the expanded graphite in the above-described total amount is required to be set to 3 to 15 wt %, and preferably 5 to 10 wt %.

When the content of the expanded graphite, serving as the conductive material and the buffering material (cushion), in the total amount of the nickel oxyhydroxide, the electrolytic manganese dioxide and the expanded graphite is less than 3 wt %, it is not possible to maintain sufficient electrical connection between the positive electrode active materials. On the other hand, when the content of the expanded graphite is greater than 15 wt %, the proportion of the active material in the positive electrode material mixture is relatively small, so that it is not possible to obtain a sufficient battery capacity.

When comparing electrolytic manganese dioxide and nickel oxyhydroxide, electrolytic manganese dioxide is superior in terms of the capacity per unit weight (mAh/g), the ease of filling into a case, and the material price, for example. On the other hand, nickel oxyhydroxide is superior in terms of the discharge voltage and the heavy load discharge characteristics. Therefore, in view of the balance in the battery characteristics and the price, the content of the electrolytic manganese dioxide in the total of the nickel oxyhydroxide and the electrolytic manganese dioxide that are included in the positive electrode material mixture is preferably 20 to 90 wt %, and more preferably 40 to 70 wt %.

Additionally, the BET specific surface area of the nickel oxyhydroxide is preferably 10 to 20 m²/g, for example, and the average particle diameter on a volume basis (D₅₀) is preferably 10 to 20 μm. Further, the average particle diameter on a volume basis (D₅₀) of the electrolytic manganese dioxide is preferably 30 to 50 μm.

Hereinafter, the present invention is specifically described by way of examples; however, the present invention is not limited to these.

### EXAMPLE 1

### Preparation of Source Material Nickel Hydroxide

Pure water and a small amount of hydrazine (reducing agent) were poured into a reaction vessel provided with a stirring blade, followed by operating the stirring blade. While performing bubbling with a nitrogen gas, a nickel (II) sulfate aqueous solution, a manganese (II) sulfate aqueous solution, a sodium hydroxide aqueous solution and ammonia water having predetermined concentrations were dispensed with pumps into the water, which was being stirred in the vessel, such that the solution in the vessel had a constant pH of 12.5 and a constant temperature of 50° C. During this operation, the solution in the vessel was kept stirred sufficiently, thereby precipitating and growing spherical nickel hydroxide, which was a solid solution including manganese dissolved therein and comprising a β-type structured crystal.

Subsequently, the obtained solid solution nickel hydroxide was heated in a sodium hydroxide aqueous solution that was different from the one described above, thus removing sulfate ions. Thereafter, the solid solution was subjected to washing with water and vacuum drying, followed by air oxidation at 80° C. for 72 hours, thereby oxidizing only Mn to a valence near 4.

The composition of the resulting solid solution nickel hydroxide was Ni_{0.95}Mn_{0.05}(OH)₂, and the average particle diameter on a volume basis measured by a laser diffraction particle size distribution analyzer was 18 μm, the BET specific surface area was 12 m²/g, and the tap density after a total of 500 times of tapping (hereinafter, described as “tap density (500 times)”) was 2.2 g/cm³.

### Preparation of Nickel Oxyhydroxide

Subsequently, 200 g of the solid solution nickel hydroxide was introduced into 1 L of a 1 mol/L sodium hydroxide aqueous solution, and a sufficient amount of a sodium hypochlorite aqueous solution (effective chlorine concentration: 5 wt %) serving as an oxidizing agent was added thereto, followed by stirring to convert the nickel hydroxide into nickel oxyhydroxide. The resulting solid solution nickel oxyhydroxide (hereinafter, “nickel oxyhydroxide P”) was sufficiently washed with water, and then subjected to vacuum drying at 60° C. for 24 hours.

Further, nickel oxyhydroxide Q was obtained under the same conditions as described above, except that 0.02 mol/L sodium hydroxide was used in place of 1 mol/L sodium hydroxide aqueous solution.

The nickel oxyhydroxide P had the following physical properties.

Average particle diameter on a volume basis: 19 μm

BET specific surface area: 14 m²/g

Tap density (500 times): 2.0 g/cm³

On the other hand, the nickel oxyhydroxide Q had the following physical properties.

Average particle diameter on a volume basis: 17 μm

BET specific surface area: 15 m²/g

Tap density (500 times): 2.3 g/cm³

The average nickel valences of the thus produced nickel oxyhydroxides were determined by the chemical measurement method shown below.

—Measurement of Nickel Content in Nickel Oxyhydroxide—

For measuring the content of nickel, a gravimetric method, which achieves high precision of analysis, was used.

First, the nickel oxyhydroxide: 0.05 g was added with 10 cm³ of concentrated nitric acid, and heated and dissolved, followed by adding thereto 10 cm³ of a tartaric acid aqueous solution and further adding thereto ion exchanged water, thereby adjusting the total volume to 200 cm³. After adjusting the pH of the resulting solution using ammonia water and acetic acid, 1 g of potassium bromate was added to oxidize manganese ions that could cause measurement error to a valence of not less than 3.

Next, an ethanol solution of dimethylglyoxime was added to this solution under stirring, thus precipitating the nickel (II) ions as a complex compound of dimethylglyoxime. Subsequently, suction filtration was performed, and the produced precipitate was collected and dried in an atmosphere with 110° C., and the weight of the precipitate was measured.

From the above-described operation, the content of nickel in the nickel oxyhydroxide was calculated using the following expression:
Content of nickel={weight of precipitate(g)×0.2032}/{weight of nickel oxyhydroxide sample(g)}
—Measurement of Manganese Content in Nickel Oxyhydroxide—

Quantitative determination was made for the manganese content by adding a nitric acid aqueous solution to the nickel oxyhydroxide, heating and dissolving it, followed by carrying out ICP emission spectrometry on the resulting solution. As the measurement apparatus, a “VISTA-RL” manufactured by VARIAN, Inc. was used.

—Measurement of Average Nickel Valence by Redox Titration—

The nickel oxyhydroxide: 0.2 g was added with 1 g of potassium iodide and 25 cm³ of sulfuric acid, and completely dissolved by continuing sufficient stirring, and the resulting solution was stood still for 20 minutes. During this process, nickel ions and manganese ions having a high valence oxidized the potassium iodide to iodine, and these ions themselves were reduced to a valence of 2. After the solution was stood still for 20 minutes, an acetic acid-ammonium acetate aqueous solution as a pH buffer solution and ion exchanged water were added thereto to stop the reaction.

Subsequently, the produced free iodine was titrated using a 0.1 mol/L sodium thiosulfate aqueous solution. The titer at this time reflects the amount of the above-described metal ions having a valence greater than 2. Therefore, using the previously obtained nickel content and manganese content, the average valence of the nickel included in the nickel oxyhydroxide was estimated, provisionally assuming that the average valence of the manganese in the nickel oxyhydroxide was 4. As a result, the average valence of the nickel in the nickel oxyhydroxide P was estimated to be 3.12, and the average valence of the nickel in the nickel oxyhydroxide Q was estimated to be 3.01.

### Preparation of Graphite Conductive Material

In this example, graphites having physical property values and the like listed in Table 1 were used as the conductive material included in the positive electrode material mixture.

Graphites a and b are scale-like natural graphites obtained by highly purifying Chinese ore after pulverization and classification, and the graphite a and the graphite b differ in the degree of pulverization and classification, and in the average particle diameter.

Graphites c and d are artificial graphites obtained by pulverizing and classifying coal-derived pitch coke after carbonization and graphitization, and the graphite c and the graphite d differ in the degree of pulverization and classification, and in the average particle diameter.

Graphites e and f are expanded graphite obtained by pulverizing and classifying scale-like natural graphite after expansion (interlayer extension) by heat treatment in sulfuric acid, and the graphite e and the graphite f differ in the degree of pulverization and classification, and in the average particle diameter.

Graphites g and h are expanded graphite obtained by pulverizing and classifying scale-like natural graphite after sufficiently high purification by washing treatment with hydrofluoric acid and the subsequent expansion (interlayer extension) by heat treatment in sulfuric acid, and the graphite g and the graphite h differ in the degree of pulverization and classification, and in the average particle diameter.

The physical property values shown in Table 1 are described below.

<1> The bulk specific gravity (apparent density) was measured in accordance with a static method defined in JIS-K5101.

<2> The average particle diameter on a volume basis was measured by a wet method using a laser diffraction particle size distribution measurement apparatus “Microtrack FRA” manufactured by NIKKISO CO.

<3> The BET specific surface area was measured by drying and evacuating the samples and then causing the samples to adsorb a N₂ gas, using a specific surface area measurement apparatus “ASAP2010” manufactured by SHIMADZU CORPORATION.

<4> The interplanar spacing of the (002) plane: d₀₀₂ determined by powder X-ray diffraction (XRD) and the crystallite size Lc (002) were measured in accordance with the method defined by the 117th Committee of the Japan Society for the Promotion of Science.

TABLE 1

| | | Physical properties of graphite | | | | | | |
|---|---|---|---|---|---|---|---|---|
| | | | | Bulk | | | Physical | |
| | | | BET | specific | | | properties of | |
| | | Average | specific | gravity | | | precursor | |
| | | particle | surface | (apparent | XRD | XRD | Impurity | Iron |
| | | diameter(D₅₀) | area | density) | d₀₀₂ | L_{c}(002) | content | content |
| Graphite | Precursor | (μm) | (m²/g) | (g/m³) | (Å) | (Å) | (wt %) | (wt %) |
| a | Scale-like | 35 | 3.9 | 0.13 | 3.355 | >1000 | 0.28 | 0.02 |
| | natural | | | | | | | |
| | graphite | | | | | | | |
| b | Scale-like | 15 | 7.4 | 0.11 | 3.354 | >1000 | 0.25 | 0.02 |
| | natural | | | | | | | |
| | graphite | | | | | | | |
| c | Artificial | 33 | 3.8 | 0.15 | 3.365 | 550 | 0.02 | ND |
| | graphite | | | | | | | |
| d | Artificial | 16 | 6.8 | 0.12 | 3.365 | 500 | 0.03 | ND |
| | graphite | | | | | | | |
| e | Expanded | 25 | 4.5 | 0.09 | 3.376 | 200 | 0.27 | 0.03 |
| | graphite | | | | | | | |
| f | Expanded | 15 | 8.8 | 0.07 | 3.377 | 200 | 0.26 | 0.02 |
| | graphite | | | | | | | |
| g | High-purity | 23 | 4.1 | 0.08 | 3.375 | 250 | 0.02 | ND |
| | expanded | | | | | | | |
| | graphite | | | | | | | |
| h | High-purity | 12 | 7.2 | 0.07 | 3.375 | 250 | 0.03 | ND |
| | expanded | | | | | | | |
| | graphite | | | | | | | |

(ND: not detected)

Production of Positive Electrode Material Mixture Pellets

A positive electrode material mixture powder was obtained by mixing the electrolytic manganese dioxide, the nickel oxyhydroxide P and the graphite a at a weight ratio of 46:46:8, and further adding and mixing thereto zinc oxide in an amount corresponding to 5 wt % of the nickel oxyhydroxide P. After 1 part by weight of an alkaline electrolyte was added per 100 parts by weight of the total of the nickel oxyhydroxide P and the manganese dioxide, the positive electrode material mixture powder was stirred with a mixer, and then formed into particulates with a predetermined particle size, while being mixed homogeneously. Here, as the alkaline electrolyte, a 40 wt % potassium hydroxide aqueous solution was used. The resulting particulates were pressure-molded into a shape of a hollow cylinder, thereby obtaining a positive electrode material mixture pellet A1.

Further, positive electrode material mixture pellets B1 to H1 were obtained using the graphites b to h, respectively, in place of the graphite a, with the weights and the like of the positive electrode materials being the same as those described above.

Further, positive electrode material mixture pellets A2 to H2 were obtained using the nickel oxyhydroxide Q in place of the nickel oxyhydroxide P in combination with the graphites a to h, respectively, with the weights and the like of the positive electrode materials being the same as those described above.

Fabrication of Nickel-Manganese Batteries

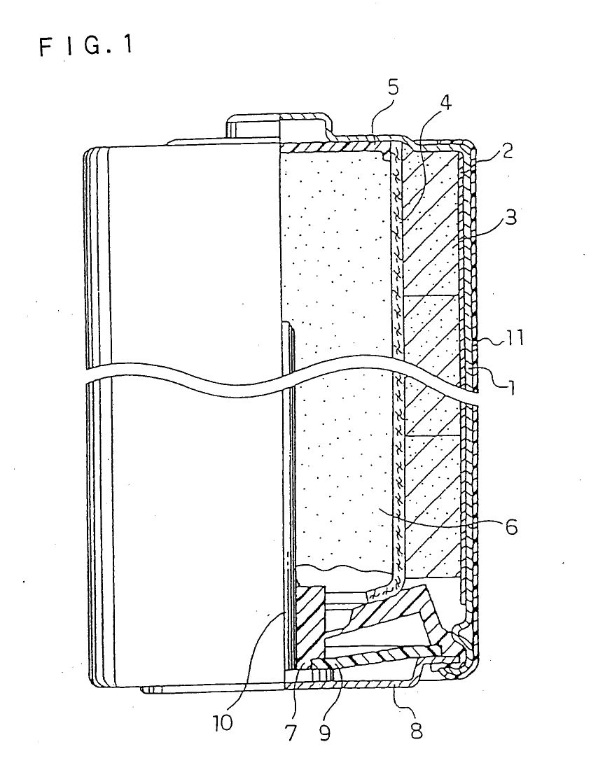

AA-sized nickel-manganese batteries A1 to H1 and A2 to H2 were fabricated using the above-described positive electrode material mixture pellets A1 to H1 and A2 to H2, respectively. FIG. 1 shows a front view, partially in cross section, showing the nickel-manganese batteries fabricated here.

As a positive electrode case 1 also serving as a positive electrode terminal, a can-shaped case comprising a nickel-plated steel plate was used. A graphite coating film 2 was formed on the inner surface of the positive electrode case 1. Plural short cylinder-shaped positive electrode material mixture pellets 3 were inserted into the positive electrode case 1. Subsequently, the positive electrode material mixture pellets 3 were re-pressurized in the positive electrode case 1 so as to be tightly attached to the inner surface of the positive electrode case 1. A separator 4 was inserted into the hollows of the positive electrode material mixture pellets 3 so as to be brought into contact with the inner surfaces of the hollows. An insulating cap 5 was placed at the bottom of the can-shaped case in the hollow.

Next, an alkaline electrolyte was injected into the positive electrode case 1 to wet the positive electrode material mixture pellets 3 and the separator 4. After the injection of the electrolyte, a gel-like negative electrode 6 was filled inside the separator 4. As the gel-like negative electrode 6, the one comprising sodium polyacrylate serving as a gelling agent, an alkaline electrolyte and a zinc powder serving as a negative electrode active material was used. A 40 wt % potassium hydroxide aqueous solution was used as the alkaline electrolyte.

Meanwhile, a resin sealing plate 7 was prepared which comprised a short cylinder-shaped central portion and an outer circumferential portion having a small thickness, wherein the outer circumferential portion had an inner groove at its peripheral edge. The peripheral edge of a bottom plate 8 also serving as a negative electrode terminal was fitted into the inner groove at the peripheral edge of the sealing plate 7. An insulating washer 9 was interposed between the sealing plate 7 and the bottom plate 8. A nail-shaped negative electrode current collector 10 was inserted into the hollow of the central portion of the sealing plate 7.

The negative electrode current collector 10 that had been previously integrated in one piece with the sealing plate 7, the bottom plate 8 and the insulating washer 9 as described above was inserted into the gel-like negative electrode 6. Subsequently, the opening end of the positive electrode case 1 was clamped to the peripheral edge of the bottom plate 8 via the peripheral edge of the sealing plate 7, thus sealing the opening of the positive electrode case 1. Finally, the outer surface of the positive electrode case 1 was covered with an outer jacket label 11, thereby completing a nickel-manganese battery.

Evaluation of Batteries

<Low Load Discharge Characteristics>

Each of the nickel-manganese batteries A1 to H1 and A2 to H2 in the initial state was continuously discharged at 20° C. with a constant current of 50 mA, and the discharge capacity obtained during a period in which the battery voltage reached 0.9 V was measured.

<Heavy Load Discharge Characteristics>

Each of the nickel-manganese batteries A1 to H1 and A2 to H2 in the initial state was continuously discharged at 20° C. with a constant power of 1 W, and the discharge time until the battery voltage reached an end voltage of 0.9 V was measured.

<Discharge Capacity after Storage>

Each of the batteries A1 to H1 and A2 to H2 that had been stored at 80° C. for three days was continuously discharged at 20° C. with a constant power of 1 W, and the discharge time until the battery voltage reached an end voltage of 0.9 V was measured.

For each of the characteristics, the result obtained for each of the batteries is shown in Table 2 as a relative value to the battery A2, taking the discharge capacity or the discharge time obtained for the battery A2 as the reference value 100.

TABLE 2

| | | Nickel oxyhydroxide P (valence 3.12) | | | | Nickel oxyhydroxide Q (valence 3.01) | | | |
|---|---|---|---|---|---|---|---|---|---|
| | | | | | Discharge | | | | Discharge |
| | | | 50 mA | 1 W | after | | 50 mA | 1 W | after |
| Graphite | Precursor | Battery | discharge | discharge | storage | Battery | discharge | discharge | storage |
| a | Scale-like | A1 | 103 | 97 | 99 | A2 | 100 | 100 | 100 |
| | natural | | | | | | | | |
| | graphite | | | | | | | | |
| b | Scale-like | B1 | 108 | 100 | 97 | B2 | 101 | 100 | 98 |
| | natural | | | | | | | | |
| | graphite | | | | | | | | |
| c | Artificial | C1 | 105 | 98 | 101 | C2 | 99 | 99 | 101 |
| | graphite | | | | | | | | |
| d | Artificial | D1 | 109 | 101 | 99 | D2 | 100 | 99 | 99 |
| | graphite | | | | | | | | |
| e | Expanded | E1 | 115 | 113 | 101 | E2 | 100 | 100 | 100 |
| | graphite | | | | | | | | |
| f | Expanded | F1 | 118 | 115 | 100 | F2 | 101 | 100 | 96 |
| | graphite | | | | | | | | |
| g | High-purity | G1 | 114 | 112 | 106 | G2 | 100 | 99 | 101 |
| | expanded | | | | | | | | |
| | graphite | | | | | | | | |
| h | High-purity | H1 | 118 | 115 | 104 | H2 | 101 | 100 | 98 |
| | expanded | | | | | | | | |
| | graphite | | | | | | | | |

In Table 2, in the case of using the nickel oxyhydroxide Q, which had an average nickel valence of approximately 3.0, there was almost no difference observed in characteristics among the batteries A2 to H2, which used different kinds of graphite conductive materials. On the other hand, in the case of using the nickel oxyhydroxide P, which had a sufficiently high average nickel valence, as the active material, use of the expanded graphites (e to h) as the conductive material improved the low load discharge characteristics (50 mA discharge) and the heavy load discharge characteristics (1 W discharge) more significantly than use of the rest of the graphites (a to d).

Highly oxidized nickel oxyhydroxide includes a γ-type structured crystal (γ—NiOOH), and γ—NiOOH undergoes structural change during discharging to become a β-type or α-type nickel hydroxide. Since the nickel oxyhydroxide undergoes a large volume change at that time, it is not possible, with the common graphites (a to d), to successfully ensure current collection between the active material particles during discharge, so that the capacity remains low. On the other hand, it seems that, since the expanded graphites (e to h) are excellent in compressibility and stress relaxation, the expanded graphites serve as the buffering material for volume change even if there is a volume change in the highly oxidized nickel oxyhydroxide, thus making it possible to ensure sufficient electrical connection between the active materials.

It should be noted that the batteries using the highly oxidized nickel oxyhydroxide have a tendency to experience a greater decrease in the heavy load discharge (1 W discharge) characteristics than the batteries using the nickel oxyhydroxide (β—NiOOH) comprising a β-type structured crystal and including zinc or cobalt dissolved therein instead of manganese. Although the batteries E1 to H1 according to the present invention also show this tendency, they achieved the high level values 112 to 115 (Table 2) despite of the decrease, and therefore, they realized better performance than the above-described batteries using β—NiOOH. Accordingly, it can be seen that the present invention can achieve higher performance than the existing alkaline batteries in terms of a capacity increase not only for the low load discharge (50 mA discharge), but also for the entire region, ranging from low load to heavy load.

Each of the batteries E1 to H1 of the present invention ensures a relatively high performance also in terms of the battery storage characteristics. Particularly, the batteries using the expanded graphites g and h, which were obtained from graphite that had been subjected to high purification, achieved high characteristics. It should be appreciated that the reaction between the graphite and the electrolyte was significantly suppressed for the high-purity expanded graphite because the BET specific surface area was suppressed to a relatively small value and the contents of the impurity and the iron were suppressed low.

Next, the same tests as those described above were carried out, except that various nickel oxyhydroxides having an average nickel valence of not less than 3.05 and less than 3.12 were used in place of the nickel oxyhydroxide P, which had an average nickel valence of 3.12. As a result, in each case, good discharge characteristics and good storage characteristics were achieved in the case of using the expanded graphites, as in the case of using the nickel oxyhydroxide P. Further, the same tests as those described above were carried out, except that various nickel oxyhydroxides having an average nickel valence of greater than 3.01 and not more than 3.04, and as a result, there was no particular improvement in discharge characteristics or storage characteristics even in the case of using the expanded graphite.

### EXAMPLE 2

In order to reveal the optimum content of the expanded graphite included in the positive electrode material mixture, the following evaluation was carried out using the expanded graphite f.

Positive electrode material mixture powders X1, X2, X3, X4, X5 and X6 were obtained by mixing the electrolytic manganese dioxide and the nickel oxyhydroxide P at a weight ratio of 50:50, further adding zinc oxide thereto in an amount corresponding to 5 wt % of the nickel oxyhydroxide P, and further mixing thereto the graphite f such that the content of the graphite f in the total amount of the nickel oxyhydroxide P, the electrolytic manganese dioxide and the graphite f was 0.5 wt %, 1 wt %, 3 wt %, 5 wt %, 8 wt % and 15 wt %, respectively.

AA-sized nickel-manganese batteries X1 to X6 were fabricated in the same manner as in Example 1, except for using the above-mentioned positive electrode material mixture powders X1 to X6, respectively, and these were evaluated in the same manner as in <Low load discharge characteristics> and <Heavy load discharge characteristics> in Example 1.

For each of the characteristics, the result obtained for each of the batteries is shown in Table 3 as a relative value to the battery A2, taking the discharge capacity or the discharge time obtained for the battery A2 of Example 1 as the reference value 100.

TABLE 3

| | Graphite | | |
|---|---|---|---|
| | content | 50 mA | 1 W |
| Battery | (wt %) | discharge | discharge |
| X1 | 0.5 | 95 | 90 |
| X2 | 1 | 98 | 94 |
| X3 | 3 | 113 | 110 |
| X4 | 5 | 116 | 113 |
| X5 | 8 | 118 | 115 |
| X6 | 15 | 110 | 111 |

From Table 3, it can be seen that relatively favorable characteristics were obtained when the content of the expanded graphite f was not less than 3 wt %. In addition, the proportion of the active material in the positive electrode material mixture relatively decreases with an increase of the content of the expanded graphite f, so that there is a fear of a disadvantage to achievement of high capacity, and also of a reduction in the storage characteristics. In view of these aspects, it can be inferred that the upper limit of the content of the expanded graphite f is about 15 wt %.

### EXAMPLE 3

In order to make findings as to attachment of a cobalt oxide to the surface of the nickel oxyhydroxide particles, the following evaluation was carried out.

### Preparation of Nickel Hydroxide Carrying Cobalt Hydroxide Thereon

Nickel hydroxide (composition: Ni_{0.95}Mn_{0.05}(OH)₂) that is the same as the source material nickel hydroxide prepared in Example 1 was introduced into a cobalt sulfate aqueous solution in a reaction vessel, a sodium hydroxide aqueous solution was gradually added thereto, and stirring was continuously performed in the vessel, while controlling the solution in the vessel so as to have a constant temperature of 35° C. and a constant pH of 10. As a result, cobalt hydroxide was precipitated on the surface of the particles of the source material nickel hydroxide. The amount of the cobalt hydroxide precipitated on the surface of the nickel hydroxide particles was adjusted to be 2 wt %, relative to the amount of the source material nickel hydroxide.

Oxidation of Cobalt Hydroxide

Subsequently, 200 g of the nickel hydroxide carrying cobalt hydroxide thereon was introduced into 1 L of a 1 mol/L sodium hydroxide aqueous solution, and a sufficient amount of a sodium hypochlorite aqueous solution (effective chlorine concentration: 5 wt %) serving as an oxidizing agent was added thereto, followed by stirring. At that time, the cobalt hydroxide was oxidized into a highly oxidized state, while the nickel hydroxide was oxidized into nickel oxyhydroxide at the same time. The resulting particles were sufficiently washed with water, and subjected to vacuum drying at 60° C. for 24 hours, thereby obtaining nickel oxyhydroxide R.

Further, nickel oxyhydroxide S was obtained under the same conditions as those described above, except that a 0.02 mol/L sodium hydroxide aqueous solution was used in place of the 1 mol/L sodium hydroxide aqueous solution used during the oxidation of nickel hydroxide.

The average nickel valences of the nickel oxyhydroxides R and S obtained here were also measured by the same method performed in Example 1. As a result, the average nickel valence of the nickel oxyhydroxide R was about 3.1, which indicated a highly oxidized state, and the average nickel valence of the nickel oxyhydroxide S was about 3.0.

Production of Positive Electrode Material Mixture Pellets

A positive electrode material mixture powder was obtained by mixing the electrolytic manganese dioxide, the nickel oxyhydroxide R and the graphite a at a weight ratio of 46:46:8, and further adding and mixing thereto zinc oxide in an amount corresponding to 5 wt % of the nickel oxyhydroxide R. After 1 part by weight of an alkaline electrolyte was added per 100 parts by weight of the total of the nickel oxyhydroxide R and the manganese dioxide, the positive electrode material mixture powder was stirred with a mixer, and then formed into particulates with a predetermined particle size, while being mixed homogeneously. Here, as the alkaline electrolyte, a 40 wt % potassium hydroxide aqueous solution was used. The resulting particulates were pressure-molded into a shape of a hollow cylinder, thereby obtaining a positive electrode material mixture pellet A3.

Further, positive electrode material mixture pellets B3 to H3 were obtained using the graphites b to h, respectively, in place of the graphite a, with the weights and the like of the positive electrode materials being the same as those described above.

Further, positive electrode material mixture pellets A4 to H4 were obtained using the nickel oxyhydroxide S in place of the nickel oxyhydroxide R in combination with the graphites a to h, respectively, with the weights and the like of the positive electrode materials being the same as those described above.

Fabrication of Nickel-Manganese Batteries

AA-sized nickel-manganese batteries A3 to H3 and A4 to H4 were fabricated in the same manner as in Example 1, using the above-described positive electrode material mixture pellets A3 to H3 and A4 to H4, respectively.

Then, the obtained batteries were evaluated in the same manner as in <Low load discharge characteristics>, <Heavy load discharge characteristics> and <Discharge capacity after storage> in Example 1. For each of the characteristics, the result obtained for each of the batteries is shown in Table 4 as a relative value to the battery A2, taking the discharge capacity or the discharge time obtained for the battery A2 of Example 1 as the reference value 100.

TABLE 4

| | | Nickel oxyhydroxide R (valence 3.1) | | | | Nickel oxyhydroxide S (valence 3.0) | | | |
|---|---|---|---|---|---|---|---|---|---|
| | | | | | Discharge | | | | Discharge |
| | | | 50 mA | 1 W | after | | 50 mA | 1 W | after |
| Graphite | Precursor | Battery | discharge | discharge | storage | Battery | discharge | discharge | storage |
| a | Scale-like | A3 | 117 | 100 | 99 | A4 | 102 | 101 | 100 |
| | natural | | | | | | | | |
| | graphite | | | | | | | | |
| b | Scale-like | B3 | 115 | 103 | 96 | B4 | 101 | 102 | 96 |
| | natural | | | | | | | | |
| | graphite | | | | | | | | |
| c | Artificial | C3 | 112 | 101 | 101 | C4 | 102 | 103 | 100 |
| | graphite | | | | | | | | |
| d | Artificial | D3 | 114 | 104 | 100 | D4 | 101 | 102 | 98 |
| | graphite | | | | | | | | |
| e | Expanded | E3 | 121 | 119 | 103 | E4 | 102 | 103 | 98 |
| | graphite | | | | | | | | |
| f | Expanded | F3 | 120 | 116 | 103 | F4 | 101 | 102 | 97 |
| | graphite | | | | | | | | |
| g | High-purity | G3 | 118 | 115 | 105 | G4 | 102 | 100 | 100 |
| | expanded | | | | | | | | |
| | graphite | | | | | | | | |
| h | High-purity | H3 | 120 | 118 | 104 | H4 | 103 | 102 | 97 |
| | expanded | | | | | | | | |
| | graphite | | | | | | | | |

In Table 4, in the case of using the nickel oxyhydroxide S, which had an average nickel valence of approximately 3.0 and had a cobalt oxide attached on the surface of its particles, there was almost no difference observed in characteristics among the batteries A4 to H4, which used different kinds of graphite conductive materials. On the other hand, in the case of using the nickel oxyhydroxide R, which had a sufficiently high average nickel valence and had a cobalt oxide attached on the surface of its particles, as the active material (A3 to H3), use of the expanded graphites (e to h) as the conductive material improved the low load discharge characteristics (50 mA discharge) more significantly than use of the rest of the graphites (a to d), and the heavy load discharge characteristics (1 W discharge) was significantly improved for the batteries E3 to H3. Furthermore, since attaching the highly conductive cobalt oxide to the surface of the nickel oxyhydroxide improved the current collection between the particles even further, the performances of the batteries A3 to H3 were further improved, as compared with those of the batteries A1 to H1 in Table 2.

### EXAMPLE 4

In order to reveal the optimum amount of the cobalt oxide attached to the surface of nickel oxyhydroxide, the following evaluation was carried out using the expanded graphite f.

Nickel hydroxide carrying cobalt hydroxide thereon was prepared in the same manner as in Example 3, except that the amount of the cobalt hydroxide precipitated on the surface of the nickel hydroxide particles was adjusted to be 1 wt %, relative to the amount of the source material nickel hydroxide, and, subsequently, 200 g of the nickel hydroxide carrying cobalt hydroxide thereon was introduced into 1 L of a 1 mol/L sodium hydroxide aqueous solution, and a sufficient amount of a sodium hypochlorite aqueous solution (effective chlorine concentration: 5 wt %) serving as an oxidizing agent was added thereto, followed by stirring. At that time, the cobalt hydroxide was oxidized into a highly oxidized state, while the nickel hydroxide was oxidized into nickel oxyhydroxide at the same time. The resulting particles were sufficiently washed with water, and subjected to vacuum drying at 60° C. for 24 hours, thereby obtaining nickel oxyhydroxide T1.

Further, nickel oxyhydroxides T2 to T9 were produced in the same manner as described above, except that the amount of the cobalt hydroxide precipitated on the surface of the nickel hydroxide particles was adjusted to be 2 wt %, 3 wt %, 4 wt %, 5 wt %, 6 wt %, 7 wt %, 8 wt % and 9 wt %, respectively, relative to the amount of the source material nickel hydroxide.

Production of Positive Electrode Material Mixture Pellets

A positive electrode material mixture powder was obtained by mixing the electrolytic manganese dioxide, the nickel oxyhydroxide T1 and the graphite a at a weight ratio of 46:46:8, and further adding and mixing thereto zinc oxide in an amount corresponding to 5 wt % of the nickel oxyhydroxide T1. After 1 part by weight of an alkaline electrolyte was added per 100 parts by weight of the total of the nickel oxyhydroxide T1 and the manganese dioxide, the positive electrode material mixture powder was stirred with a mixer, and then formed into particulates with a predetermined particle size, while being mixed homogeneously. Here, as the alkaline electrolyte, a 40 wt % potassium hydroxide aqueous solution was used. The resulting particulates were pressure-molded into a shape of a hollow cylinder, thereby obtaining a positive electrode material mixture pellet Y1.

Further, positive electrode material mixture pellets Y2 to Y9 were obtained using the nickel oxyhydroxides T2 to T9, respectively, in place of the nickel oxyhydroxide T1, with the weights and the like of the positive electrode materials being the same as those described above.

Fabrication of nickel-manganese batteries AA-sized nickel-manganese batteries Y1 to Y9 were fabricated in the same manner as in Example 1, using the above-described positive electrode material mixture pellets Y1 to Y9, respectively. Practically, the battery Y2 and the battery F3 are the same battery.

Then, the obtained batteries were evaluated in the same manner as in <Low load discharge characteristics>, <Heavy load discharge characteristics> and <Discharge capacity after storage> in Example 1. For each of the characteristics, the result obtained for each of the batteries is shown in Table 5 as a relative value to the battery A2, taking the discharge capacity or the discharge time obtained for the battery A2 of Example 1 as the reference value 100.

TABLE 5

| | | Amount of | | | Discharge |
|---|---|---|---|---|---|
| | Nickel | cobalt oxide | 50 mA | 1 W | after |
| Battery | oxyhydroxide | (wt %) | discharge | discharge | storage |
| Y1 | T1 | 1 | 117 | 113 | 104 |
| Y2 | T2 | 2 | 120 | 116 | 103 |
| Y3 | T3 | 3 | 121 | 117 | 102 |
| Y4 | T4 | 4 | 122 | 118 | 102 |
| Y5 | T5 | 5 | 121 | 119 | 103 |
| Y6 | T6 | 6 | 119 | 120 | 102 |
| Y7 | T7 | 7 | 118 | 121 | 100 |
| Y8 | T8 | 8 | 119 | 123 | 95 |
| Y9 | T9 | 9 | 118 | 124 | 94 |

In the results shown in Table 5, there is a tendency that the heavy load discharge characteristics improve with an increase in the amount of the cobalt oxide attached to the nickel oxyhydroxide. On the other hand, it seems that the phenomenon in which cobalt is eluted from the positive electrode of the battery during high temperature storage is prominent when the amount of the cobalt oxide attached is excessive, so that the battery performance tends to decrease. In view of the foregoing, it seems that the amount of the cobalt oxide is preferably not more than 7 wt %, relative to the amount of the nickel oxyhydroxide.

Although a solid solution nickel hydroxide including manganese was used as the source material nickel hydroxide when obtaining highly oxidized nickel oxyhydroxide in the above-described examples, this is not intended to limit the present invention. However, a source material solid solution nickel hydroxide including manganese is preferable as the source material nickel hydroxide used in the present invention, since it easily can be highly oxidized by chemical oxidation. Additionally, to obtain highly oxidized nickel oxyhydroxide with a high nickel content, the content of the manganese in the total of the nickel and the manganese that are included in the source material nickel hydroxide is preferably 1 to 7 mol %.

Although the expanded graphites e to h having specific physical properties were used in the above-described examples, the same effect can be obtained with any expanded graphite that has an average particle diameter on a volume basis of 5 to 25 μm, a BET specific surface area of 4 to 10 m²/g and a bulk specific gravity (apparent density) measured by a static method of 0.03 to 0.10 g/cm³.

From the viewpoint of the mechanical properties of expanded graphite, such as compressibility and reducibility, and stress relaxation, it is preferable to use expanded graphite having a d₀₀₂ of not less than 3.37 Å and an Lc (002) of not more than 300 Å, and it is most preferable to use, as the precursor of the expanded graphite, high purity graphite having an impurity content of not more than 0.5 wt % and an iron content of not more than 0.05 wt % from the viewpoint of the storage characteristics of the battery. In addition, it is also possible to fabricate an alkaline battery having substantially the same characteristics by using a positive electrode material mixture that uses mainly expanded graphite as the conductive material and includes a small amount of graphite that has not been subjected to expansion treatment, carbon black, fibrous carbon or the like.

Furthermore, although the mixing ratio of the electrolytic manganese dioxide and the nickel oxyhydroxide was set to a weight ratio of 50:50 in the above-described examples, a similar alkaline battery can be obtained when the content of the electrolytic manganese dioxide in the total of the nickel oxyhydroxide and the electrolytic manganese dioxide is 20 to 90 wt %.

Furthermore, although the batteries were fabricated by adding zinc oxide to the positive electrode material mixture in an amount corresponding to 5 wt % of the nickel oxyhydroxide in the above-described examples, this is not essential to the present invention. Additionally, a so-called inside-out type structure of the alkaline battery was adopted in the above-described examples, the present invention can also be applied to alkaline batteries with other structures such as button-shaped structure and square structure.

### INDUSTRIAL APPLICABILITY

The present invention can be applied to alkaline batteries including manganese dioxide and nickel oxyhydroxide in the positive electrode material mixture as active materials, and particularly to a nickel-manganese battery as a primary battery. With the present invention, it is possible to provide an alkaline battery having high capacity and excellent storage characteristics under a wide range of discharge conditions, varying from low load discharging to heavy load discharging.

1. An alkaline battery comprising a positive electrode, a negative electrode and an alkaline electrolyte,
wherein said positive electrode includes a positive electrode material mixture including nickel oxyhydroxide, electrolytic manganese dioxide and expanded graphite,
said expanded graphite has an average particle diameter on a volume basis of 5 to 25 μm, a BET specific surface area of 4 to 10 m²/g, and a bulk specific gravity (apparent density) measured by a static method of 0.03 to 0.10 g/cm³,
said nickel oxyhydroxide has an average nickel valence of not less than 3.05, and
a content of said expanded graphite in a total amount of said nickel oxyhydroxide, said electrolytic manganese dioxide and said expanded graphite that are included in said positive electrode material mixture is 3 to 15 wt %.

2. The alkaline battery in accordance with claim 1,
wherein a content of said electrolytic manganese dioxide in a total of said nickel oxyhydroxide and said electrolytic manganese dioxide is 20 to 90 wt %.

3. The alkaline battery in accordance with claim 1,
wherein said expanded graphite has an interplanar spacing of the (002) plane: d₀₀₂ determined by powder X-ray diffraction of not less than 3.37 Å and a crystallite size: Lc (002) of not more than 300 Å.

4. The alkaline battery in accordance with claim 1,
wherein said expanded graphite is obtained by expanding a high purity graphite precursor, and said precursor has an impurity content of not more than 0.2 wt %, and an iron content constituting said impurity is not more than 0.05 wt % of said precursor.

5. The alkaline battery in accordance with claim 1,
wherein said nickel oxyhydroxide is a solid solution including at least manganese dissolved therein.

6. The alkaline battery in accordance with claim 5,
wherein a content of said manganese in a total of nickel and said manganese that are included in said nickel oxyhydroxide is 1 to 7 mol %.

7. The alkaline battery in accordance with claim 1,
wherein said nickel oxyhydroxide has cobalt oxide attached to the surface of the particles thereof.

8. The alkaline battery in accordance with claim 7,
wherein an amount of said cobalt oxide is not more than 7 wt %, relative to an amount of said nickel oxyhydroxide.
